(19) United States
(12) Patent Application Publication
(10) Pub. No.: US 2017/0098165 A1
(43) Pub. Date: Apr. 6, 2017

(54) Method and Apparatus for Establishing and Using User Recommendation Model in Social Network

(71) Applicant: Huawei Technologies Co., Ltd., Shenzhen (CN)

(72) Inventors: Qiang Yang, Shenzhen (CN); Yi Zhen, Hong Kong (CN); Wenyuan Dai, Shenzhen (CN)

(21) Appl. No.: 15/383,759

(22) Filed: Dec. 19, 2016

Related U.S. Application Data
(63) Continuation of application No. PCT/CN2015/071382, filed on Jan. 23, 2015.

(30) Foreign Application Priority Data
Jun. 20, 2014 (CN) 201410281345.9

(51) Int. Cl. G06N 5/04; G06N 99/00; H04L 29/08; G06N 7/00

(52) U.S. Cl. CPC G06N 5/04; G06N 7/005; G06N 99/005; H04L 67/10

(57) ABSTRACT

A method and an apparatus for establishing and using a user recommendation model in a social network. The method includes obtaining training data from the social network, performing heterogeneous data transfer learning on the training data to learn a semanteme of the training data, establishing an association between a user and the image data by using the text data as a medium, establishing a semantic association relationship between the image data and the user according to the semanteme of the training data and the association between the user and the image data, and establishing a user recommendation model according to the semantic association relationship, where the user recommendation model includes the semantic association relationship between the image data and the user.

### CROSS-REFERENCE TO RELATED APPLICATIONS

This application is a continuation of International Application No. PCT/CN2015/071382, filed on Jan. 23, 2015, which claims priority to Chinese Patent Application No. 201410281345.9, filed on Jun. 20, 2014, both of which are hereby incorporated by reference in their entireties.

### TECHNICAL FIELD

The present disclosure relates to the field of communications technologies, and in particular to a method and an apparatus for establishing a user recommendation model in a social network.

### BACKGROUND

Social networks, such as a microblog, have become an essential part of the life of common users. In a microblog, following an interested famous microblog user, for example, a microblog big V user, is a first step of using the microblog by a user and is also a most important step. A data requirement of the user can be greatly satisfied as long as this step is done. Because a quantity of microblog big V users is extremely large, the user cannot find an interested microblog big V user by means of browsing. Because the data requirement of the user is hard to be expressed by using a relatively short sentence, the user cannot find enough microblog big V users by means of searching. Therefore, recommending a microblog big V user to the user is a very effective manner.

However, data of a social network such as a microblog has multiple types such as a text, an image, or a video, and is heterogeneous and massive, and a current user recommendation requirement is hard to be satisfied by using a conventional homogeneous data-based recommendation technology.

### SUMMARY

Embodiments of the present disclosure provide a method and an apparatus for establishing and using a user recommendation model in a social network, which can recommend a user based on heterogeneous data so as to resolve a technical problem in the prior art that a current user recommendation requirement is hard to be satisfied.

A first aspect of the present disclosure provides a method for establishing a user recommendation model in a social network, including obtaining training data from the social network, where the training data includes text data, image data, and user-related data, performing heterogeneous data transfer learning on the training data to learn a semanteme of the training data, establishing an association between a user and the image data by using the text data as a medium, establishing a semantic association relationship between the image data and the user according to the semanteme of the training data and the association between the user and the image data, and establishing a user recommendation model according to the semantic association relationship, where the user recommendation model includes the semantic association relationship between the image data and the user.

In a first possible implementation manner, establishing an association between a user and the image data by using the text data as a medium includes establishing an association between the image data and the text data according to the training data and establishing an association between the user and the text data according to the user-related data.

With reference to the first aspect or the first possible implementation manner of the first aspect, in a second possible implementation manner, performing heterogeneous data transfer learning on the training data to learn a semanteme of the training data includes performing heterogeneous data transfer learning on the training data by using covariance shift, multi-task learning, a sample TrAdaboost transfer learning method, a probabilistic latent semantic analysis (PLSA) algorithm, a principal component analysis (PCA) algorithm, a linear discriminant analysis (LDA) algorithm, a Bayesian model, a support vector machine, or a theme model to learn the semanteme of the training data.

A second aspect of the present disclosure provides a method for recommending a user in a social network, including obtaining related data of a target user, where the related data of the target user includes at least image data, searching, by using a user recommendation model, for a user having a semantic association relationship with the image data of the target user, where the user recommendation model is established by performing heterogeneous data transfer learning on training data, and when the semantic association relationship satisfies a preset condition, recommending a user corresponding to the semantic association relationship satisfying the preset condition to the target user.

In a first possible implementation manner, the recommending a user corresponding to the semantic association relationship satisfying the preset condition to the target user includes pushing identifier data of the user to the target user.

A third aspect of the present disclosure provides an apparatus for establishing a user recommendation model in a social network, including an obtaining module configured to obtain training data from the social network, where the training data includes text data, image data, and user-related data, a learning module configured to perform heterogeneous data transfer learning on the training data to learn a semanteme of the training data, a relationship module configured to establish an association between a user and the image data by using the text data as a medium, and establish a semantic association relationship between the image data and the user according to the semanteme of the training data and the association between the user and the image data, and an establishment module configured to establish a user recommendation model according to the semantic association relationship, where the user recommendation model includes the semantic association relationship between the image data and the user.

In a first possible implementation manner, the relationship module is configured to establish an association between the image data and the text data according to the training data and establish an association between the user and the text data according to the user-related data.

With reference to the third aspect or the first possible implementation manner of the third aspect, in a second possible implementation manner, the learning module is configured to perform heterogeneous data transfer learning on the training data by using covariance shift, multi-task learning, a sample TrAdaboost transfer learning method, a PLSA algorithm, a PCA algorithm, a LDA algorithm, a Bayesian model, a support vector machine, or a theme model to learn the semanteme of the training data.

A fourth aspect of the present disclosure provides an apparatus for recommending a user in a social network, including an obtaining module configured to obtain related data of a target user, where the related data of the target user includes at least image data, a searching module configured to search, using a user recommendation model, for a user having a semantic association relationship with the image data of the target user, where the user recommendation model is established by performing heterogeneous data transfer learning on training data, and a recommendation module configured to, when the semantic association relationship satisfies a preset condition, recommend a user corresponding to the semantic association relationship satisfying the preset condition to the target user.

In a first possible implementation manner, the recommendation module is configured to push identifier data of the user to the target user.

A fifth aspect of the present disclosure provides a computer device, where the computer device includes a processor, a memory, a bus, and a communications interface, where the memory is configured to store a computer execution instruction, the processor is connected to the memory by using the bus, and when the computer device runs, the processor executes the computer execution instruction stored in the memory so that the computer device performs the method for establishing a user recommendation model in a social network provided in the first aspect of the present disclosure or the method for recommending a user in a social network provided in the second aspect of the present disclosure.

A sixth aspect of the present disclosure provides a computer readable medium, including a computer execution instruction so that when a processor of a computer executes the computer execution instruction, the computer performs the method for establishing a user recommendation model in a social network provided in the first aspect of the present disclosure or the method for recommending a user in a social network provided in the second aspect of the present disclosure.

As can be seen from the above, in the embodiments of the present disclosure, by means of a technical solution of obtaining heterogeneous training data from a social network, learning a semanteme of the training data, establishing a semantic association relationship between image data and a user, and further establishing a heterogeneous data-based user recommendation model, the user recommendation model can be used to recommend, to a target user based on the image data, another user associated with image data of the target user so as to resolve a technical problem in the prior art that a current user recommendation requirement is hard to be satisfied.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic diagram of a method for establishing a user recommendation model in a social network according to an embodiment of the present disclosure;

FIG. 2 is a principle diagram of a method for recommending a user according to an embodiment of the present disclosure;

FIG. 3 is a schematic diagram of a method for recommending a user in a social network according to an embodiment of the present disclosure;

FIG. 4 is a schematic diagram of an apparatus for establishing a user recommendation model in a social network according to an embodiment of the present disclosure;

FIG. 5 is a schematic diagram of an apparatus for recommending a user in a social network according to an embodiment of the present disclosure; and

FIG. 6 is a schematic diagram of a computer device according to an embodiment of the present disclosure.

### DESCRIPTION OF EMBODIMENTS

Embodiments of the present disclosure provide a method and an apparatus for establishing a user recommendation model in a social network and a method and an apparatus for recommending a user in a social network, which can perform recommendation based on heterogeneous data so as to resolve a technical problem in the prior art that a current user recommendation requirement is hard to be satisfied.

To make a person skilled in the art understand the solutions in the present disclosure better, the following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

Detailed descriptions are separately provided below by means of specific embodiments.

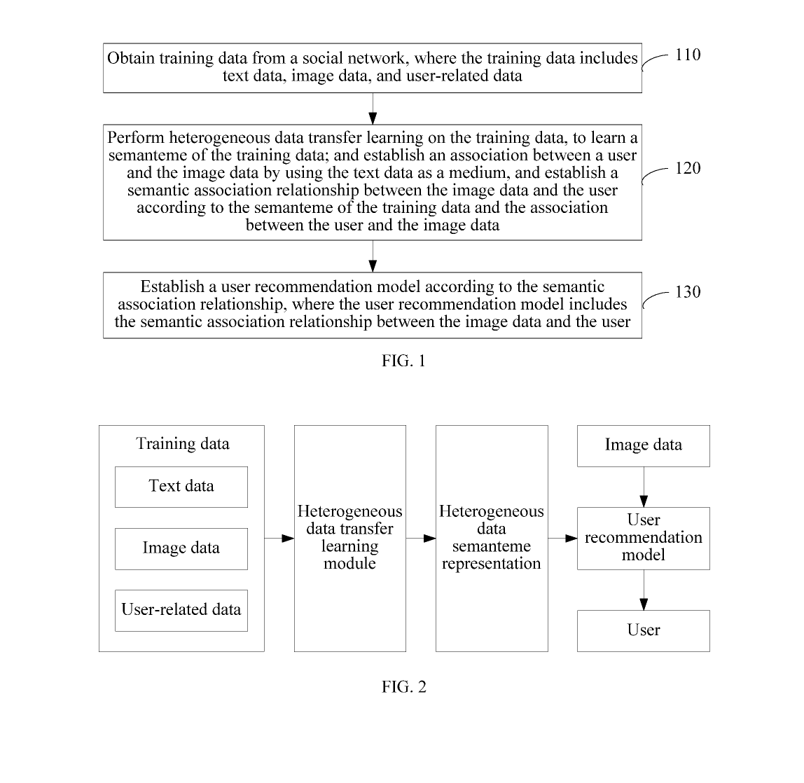

Referring to FIG. 1, a method for establishing a user recommendation model in a social network provided in an embodiment of the present disclosure may include the following steps.

110: Obtain training data from the social network, where the training data includes text data, image data, and user-related data.

In this embodiment of the present disclosure, the social network may include a microblog, a blog, QQ, WECHAT, and the like. In this specification, a microblog is used as an example for description. A server deployed in a social network, for example, a microblog system server, may obtain training data from the social network, where the training data includes text data, image data, and user-related data. The text data and the image data may be text data and image data that are extracted from various network resources. The network resources may include various portal sites, forums, or image sharing websites, for example, the image sharing website FLICKR belonging to YAHOO. The image data may include an image, a photograph, a video, and the like. Using the microblog as an example, a user preferably selects a microblog user that is famous to some extent. The user-related data may include data such as a name of the user, registration data, a posted text, a posted image, and a posted video, or may further include various other data related to the user.

120: Perform heterogeneous data transfer learning on the training data, to learn a semanteme of the training data, establish an association between a user and the image data by using the text data as a medium, and establish a semantic association relationship between the image data and the user according to the semanteme of the training data and the association between the user and the image data.

In this embodiment of the present disclosure, the obtained training data is learned by using a heterogeneous data transfer learning technology in a machine learning technology. In the principle diagram shown in FIG. 2, a microblog system server may learn obtained social network data by using a deployed heterogeneous data transfer learning module. An output result is represented by using a high-level semanteme, which includes a semanteme of a text a semanteme of an image, and the like.

In this embodiment of the present disclosure, the association between the user and the image data is further established by using the text data as a medium. The association between the text data and the image data may be established by analyzing common network data (not including other text data and image data of the user-related data) in the training data. For example, there are many shared photographs in the image-sharing website FLICKR, and each photograph is generally attached with a text label to explain content related to the photograph. Therefore, an association between the photograph and the text label may be established. Alternatively, an image may be directly analyzed by using some algorithms to obtain theme data of the image, and is represented by using text data. For example, if an image is analyzed to be a photograph of a cat, an association between text data “cat” and the image may be established. By analyzing the user-related data in the training data, for example, registration data of a microblog user or an article posted by the microblog user, an association between the microblog user and some text data is established. For example, a microblog user posts a large amount of data about sports, an association between the microblog user and text data “sports” may be established. For example, if a microblog user is a responsible person of a searching website, an association between the microblog user and text data “search” may be established.

Various types of heterogeneous data such as a text and an image cannot be analyzed or processed together. In this embodiment of the present disclosure, by means of heterogeneous data transfer learning, various types of obtained training data are represented by using high-level semantemes, and a processing operation is performed on a presentation layer of the semanteme. For the computer science, a semanteme generally refers to an explanation, offered by a user, of a computer representation (for example, a symbol) used to describe the real world, for example, a way used by the user to associate the computer representation with the real world. The semanteme refers to a semanteme hidden behind data. The semanteme is a concept, for example, a theme of an article. For example, a word “cat” and an image of a cat can both correspond to the concept of “cat”. In this embodiment of the present disclosure, a semantic association relationship, for example, an association relationship represented by a high-level semanteme, between the image data and the user may be established according to the learned semanteme of the training data and the established association between the user and the image data.

In some embodiments of the present disclosure, the performing heterogeneous data transfer learning on the training data may include: performing heterogeneous data transfer learning on the training data by using covariance shift (covariance shift), multi-task learning, a sample TrAdaboost transfer learning method, PLSA algorithm, a PCA algorithm, a LDA algorithm, a Bayesian model, a support vector machine, or a theme model to learn the semanteme of the training data.

In some embodiments of the present disclosure, based on learning the semanteme of the training data, further learning may be performed based on the learned semanteme to cluster or classify the training data so that when the semantic association relationship is subsequently established, an association relationship can be rapidly established according to different classifications or clusters.

130: Establish a user recommendation model according to the semantic association relationship, where the user recommendation model includes the semantic association relationship between the image data and the user.

In this embodiment of the present disclosure, analysis and statistics collecting may be performed according to the semantic association relationship between the image data and the user that is established in the previous step to establish the user recommendation model. The user recommendation model may include a data structure in a matrix form. One row (or one column) of a matrix may represent one recommendable user. Each column in one row may represent image data or a semanteme of the image data that has a semantic association relationship with the user. In this way, a group of users and a set of image data or a group of semantemes thereof form a matrix. Preferably, a degree or strength of the semantic association relationship may be represented in a matrix by using an association coefficient and the association coefficient may be recorded at a cross point of a row and a column.

In this embodiment of the present disclosure, the established user recommendation model may be a dynamic model. The model may be constantly improved according to learning results of step 110 and step 120.

The user recommendation model may be used to recommend a user. Image data or a semanteme of the image data is input to the user recommendation model and the user recommendation model may output a user having a semantic association relationship with the input image data. The user, for example, a microblog user, may be represented by a registration name, a nickname, or the like.

According to the method in this embodiment of the present disclosure, various pieces of training data can be constantly obtained from a social network, heterogeneous data transfer learning can be constantly performed, and the user recommendation model can be constantly improved.

It can be understood that the foregoing solution in this embodiment of the present disclosure may be implemented in a computer device such as a microblog system server.

In the foregoing, this embodiment of the present disclosure discloses the method for establishing a user recommendation model in a social network. According to the method, by means of a technical solution of obtaining heterogeneous training data from the social network, learning a semanteme of the training data, establishing a semantic association relationship between image data and a user, and further establishing a user recommendation model based on the semantic association relationship, another user associated with image data of a target user can be recommended to the target user by using the user recommendation model and based on the image data so as to resolve a technical problem in the prior art that a current user recommendation requirement is hard to be satisfied.

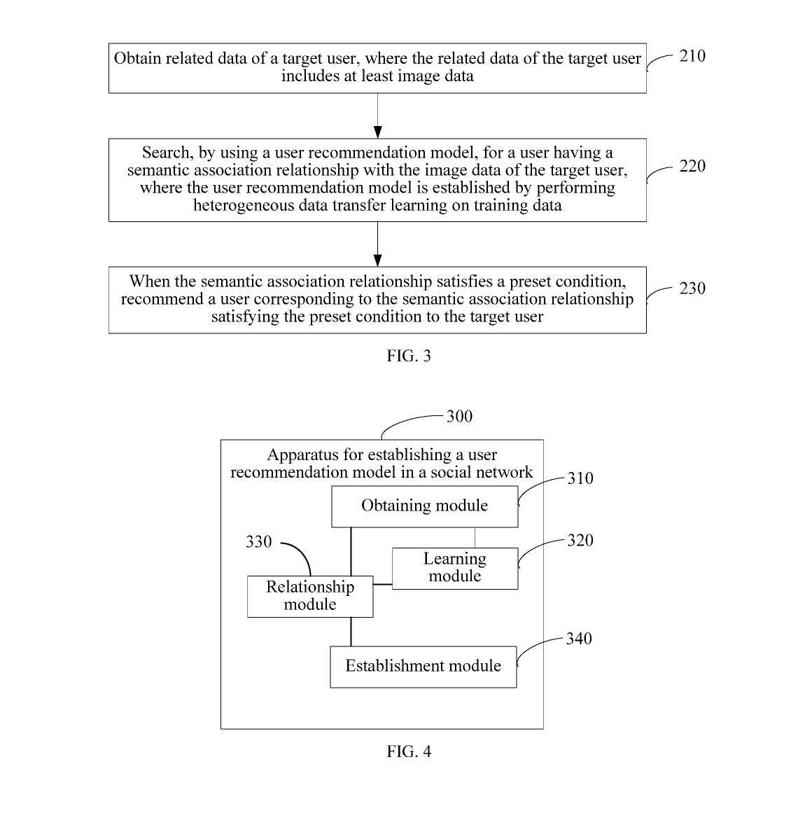

Referring to FIG. 3, an embodiment of the present disclosure further provides a method for recommending a user in a social network, including the following steps.

210: Obtain related data of a target user, where the related data of the target user includes at least image data.

220: Search, by using a user recommendation model, for a user having a semantic association relationship with the image data of the target user, where the user recommendation model is established by performing heterogeneous data transfer learning on training data.

230: When the semantic association relationship satisfies a preset condition, recommend a user corresponding to the semantic association relationship satisfying the preset condition to the target user.

In this embodiment of the present disclosure, the user recommendation model may be established by using the method disclosed in the embodiment in FIG. 1.

In this embodiment of the present disclosure, a process of recommending a user may include obtaining related data of a target user, where the related data includes image data, for example, obtaining image data from a network album publicized by a user, where in the user recommendation model established in the method disclosed in the embodiment in FIG. 1, a semantic association relationship between image data and a user is recorded. In this embodiment, users having a semantic association relationship with the image data of the target user may be searched for by using the user recommendation model, and recommending a user whose semantic association relationship satisfies a preset condition among the found users to the target user. Identifier data of the found user, such as a user name or a nickname, is pushed to the target user. In some embodiments, the preset condition may be that sorting is performed according to values of association coefficients of semantic association relationships, and users with association coefficients that are greater than a preset value or users with association coefficients that are ranked at the top of the association coefficients are deemed as satisfying the preset condition. A preset quantity of users may be recommended to the target user according to the sorting of the association coefficients. For the convenience of description, in this disclosure, a semantic association relationship satisfying the preset condition is referred to as a recommendation relationship for short.

For example, a target user may share an album of the target user, for example, an album in QQ zone or FLICKR, for a microblog system server to search. The server may obtain photographs in the albums, find a user having a recommendation relationship with the photographs, and recommend the user to the target user, for example, push identifier data of the found user to the target user, and display the identifier data on a terminal device that is being used by the target user. In some embodiments, the target user may add a label to a photograph shared with the microblog system server, to show that the target user likes the photograph or dislikes the photograph. The user recommendation model may use a photograph labeled as “like” as a positive example, and finds a user having a recommendation relationship to perform recommendation; and may use a photograph labeled as “dislike” as a negative example, and does not allow to recommend a user having a recommendation relationship with the photograph in the negative example.

According to the method in this embodiment of the present disclosure, various pieces of training data can be constantly obtained from a social network, heterogeneous data transfer learning can be constantly performed, and the user recommendation model can be constantly improved, to improve a recommendation effect, improve user experience, and improve user stickiness in use.

It can be understood that the foregoing solution in this embodiment of the present disclosure may be implemented in a computer device such as a microblog system server.

As can be seen from the above, in some implementation manners of the present disclosure, a user is recommended by using a heterogeneous data-based user recommendation model, and a related user can be recommended to a target user based on image data so as to resolve a technical problem in the prior art that a current user recommendation requirement is hard to be satisfied, for example, a technical problem in the prior art that a current microblog big V user recommendation requirement is hard to be satisfied. To better implement the foregoing solution in this embodiment of the present disclosure, the following further provides related apparatuses configured to cooperate to implement the foregoing solution.

Referring to FIG. 4, an embodiment of the present disclosure provides an apparatus 300 for establishing a user recommendation model in a social network, which may include an obtaining module 310 configured to obtain training data from the social network, where the training data includes text data, image data, and user-related data, a learning module 320 configured to perform heterogeneous data transfer learning on the training data, to learn a semanteme of the training data, a relationship module 330 configured to establish an association between a user and the image data by using the text data as a medium, and establish a semantic association relationship between the image data and the user according to the semanteme of the training data and the association between the user and the image data, and an establishment module 340 configured to establish a user recommendation model according to the semantic association relationship, where the user recommendation model includes the semantic association relationship between the image data and the user.

In some embodiments of the present disclosure, the relationship module 330 is configured to establish an association between the image data and the text data according to the training data and establish an association between the user and the text data according to the user-related data.

In some embodiments of the present disclosure, the learning module 320 is configured to perform heterogeneous data transfer learning on the training data by using covariance shift, multi-task learning, a sample TrAdaboost transfer learning method, a PLSA algorithm, a PCA algorithm, a LDA algorithm, a Bayesian model, a support vector machine, or a theme model to learn the semanteme of the training data.

It can be understood that the apparatus in this embodiment of the present disclosure may be a computer device such as a microblog system server.

It may be understood that, functions of functional modules of the apparatus in this embodiment of the present disclosure may be implemented according to the method in the foregoing method embodiment. For specific implementation processes thereof, reference may be made to related descriptions in the foregoing method embodiment, which are not described in detail herein again.

In the foregoing, this embodiment of the present disclosure discloses the apparatus for establishing a user recommendation model in a social network. The apparatus may obtain heterogeneous training data from the social network, learn a semanteme of the training data, establish a semantic association relationship between image data and a user, further establish a user recommendation model based on the semantic association relationship, and may recommend, to a target user, another user associated with image data of the target user by using the recommendation model and based on the image data so as to resolve a technical problem in the prior art that a current user recommendation requirement is hard to be satisfied.

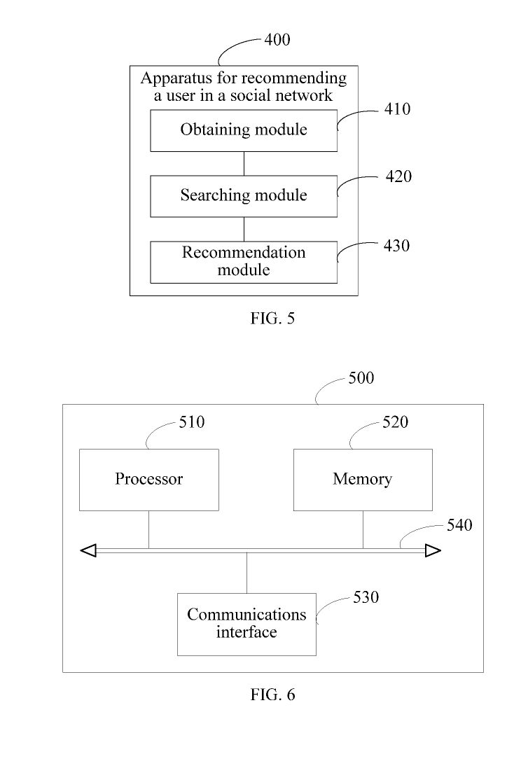

Referring to FIG. 5, an embodiment of the present disclosure provides an apparatus 400 for recommending a user in a social network, which may include an obtaining module 410 configured to obtain related data of a target user, where the related data of the target user includes at least image data, a searching module 420 configured to search, by using a user recommendation model, for a user having a semantic association relationship with the image data of the target user, where the user recommendation model is established by performing heterogeneous data transfer learning on training data, and a recommendation module 430 configured to when the semantic association relationship satisfies a preset condition, recommend a user corresponding to the semantic association relationship satisfying the preset condition to the target user.

The user recommendation model may be established by the apparatus provided in the embodiment in FIG. 4.

In some embodiments of the present disclosure, the recommendation module 430 may be configured to push identifier data of a found user to the target user.

The apparatus in this embodiment of the present disclosure may be a computer device such as a microblog system server.

It may be understood that, functions of functional modules of the apparatus in this embodiment of the present disclosure may be implemented according to the method in the foregoing method embodiment. For specific implementation processes thereof, reference may be made to related descriptions in the foregoing method embodiment, which are not described in detail herein again.

As can be seen from the above, in some feasible implementation manners of the present disclosure, a user is recommended by using a heterogeneous data-based user recommendation model, and a related user can be recommended to a target user based on image data so as to resolve a technical problem in the prior art that a current user recommendation requirement is hard to be satisfied, for example, a technical problem in the prior art that a current microblog big V user recommendation requirement is hard to be satisfied. An embodiment of the present disclosure further provides a computer readable medium, including a computer execution instruction so that when a processor of a computer performs the computer execution instruction, the computer performs the method for establishing a user recommendation model in a social network that is disclosed in the embodiment in FIG. 1, or performs the method for recommending a user in a social network that is disclosed in the embodiment in FIG. 3.

Referring to FIG. 6, an embodiment of the present disclosure further provides a computer device 500, which may include a processor 510, a memory 520, a communications interface 530, and a bus 540. The processor 510, the memory 520, and the communications interface 530 are connected to and communicate with one another by using the bus 540, the communications interface 530 is configured to receive and send data, the memory 520 is configured to store a computer execution instruction, and when the computer device runs, the processor 510 is configured to execute the computer execution instruction stored in the memory so that the computer device performs the method for establishing a user recommendation model in a social network that is disclosed in the embodiment in FIG. 1, or performs the method for recommending a user in a social network that is disclosed in the embodiment in FIG. 3.

In the foregoing, this embodiment of the present disclosure discloses the computer device. By means of a technical solution of obtaining heterogeneous training data from a social network, learning a semanteme of the training data, establishing a semantic association relationship between image data and a user, and further establishing a user recommendation model based on the semantic association relationship, the device may recommend, to a target user by using the recommendation model and based on the image data, another user associated with image data of the target user so as to resolve a technical problem in the prior art that a current user recommendation requirement is hard to be satisfied.

In the foregoing embodiments, the description of each embodiment has respective focuses. For a part that is not described in detail in an embodiment, reference may be made to related descriptions in other embodiments.

It should be noted that, for brief description, the foregoing method embodiments are represented as a series of actions. However, a person skilled in the art should appreciate that the present disclosure is not limited to the described order of the actions, because according to the present disclosure, some steps may be performed in other orders or simultaneously. In addition, a person skilled in the art should also understand that all the embodiments described in this specification belong to exemplary embodiments, and the involved actions and modules are not necessarily mandatory to the present disclosure.

A person of ordinary skill in the art may understand that all or some of the steps of the methods in the embodiments may be implemented by a program instructing relevant hardware. The program may be stored in a computer-readable storage medium. The storage medium may include a read only memory (ROM), a random access memory (RAM), a magnetic disk, or an optical disc.

The method and the apparatus for establishing a user recommendation model in a social network that are provided in the embodiments of the present disclosure are described in detail above. In this specification, specific examples are used to describe the principle and implementation manners of the present disclosure, and the description of the embodiments is only intended to help understand the method and core idea of the present disclosure. Meanwhile, a person of ordinary skill in the art may, based on the idea of the present disclosure, make modifications with respect to the specific implementation manners and the application scope. Therefore, the content of this specification shall not be construed as a limitation to the present disclosure.

What is claimed is:

1. A method for establishing a user recommendation model in a social network comprising:
obtaining training data from the social network, wherein the training data comprises text data, image data, and user-related data;
performing heterogeneous data transfer learning on the training data to learn a semanteme of the training data;
establishing a first association between a user and the image data by using the text data as a medium;
establishing a semantic association relationship between the image data and the user according to the semanteme of the training data and the first association between the user and the image data; and
establishing a user recommendation model according to the semantic association relationship, wherein the user recommendation model comprises the semantic association relationship between the image data and the user.

2. The method according to claim 1, wherein establishing the first association between the user and the image data by using the text data as the medium comprises:
establishing a second association between the image data and the text data according to the training data; and
establishing a third association between the user and the text data according to the user-related data.

3. The method according to claim 1, wherein performing the heterogeneous data transfer learning on the training data to learn the semanteme of the training data comprises performing heterogeneous data transfer learning on the training data by using covariance shift, multi-task learning, a sample TrAdaboost transfer learning method, a probabilistic latent semantic analysis (PLSA) algorithm, a principal component analysis (PCA) algorithm, a linear discriminant analysis (LDA) algorithm, a Bayesian model, a support vector machine, or a theme model to learn the semanteme of the training data.

4. A method for recommending a user in a social network comprising:
obtaining related data of a target user, wherein the related data of the target user comprises at least image data;
searching, by using a user recommendation model, for a user having a semantic association relationship with the image data of the target user, wherein the user recommendation model is established by performing heterogeneous data transfer learning on training data; and
recommending a user corresponding to the semantic association relationship satisfying a preset condition to the target user when the semantic association relationship satisfies the preset condition.

5. The method according to claim 4, wherein recommending the user corresponding to the semantic association relationship satisfying the preset condition to the target user comprises pushing identifier data of the user to the target user.

6. An apparatus for establishing a user recommendation model in a social network comprising:
a processor configured to:
obtain training data from the social network, wherein the training data comprises text data, image data, and user-related data;
perform heterogeneous data transfer learning on the training data, to learn a semanteme of the training data;
establish a first association between a user and the image data by using the text data as a medium;
establish a semantic association relationship between the image data and the user according to the semanteme of the training data and the first association between the user and the image data; and
establish a user recommendation model according to the semantic association relationship, wherein the user recommendation model comprises the semantic association relationship between the image data and the user.

7. The apparatus according to claim 6, wherein the processor is further configured to
establish a second association between the image data and the text data according to the training data; and
establish a third association between the user and the text data according to the user-related data.

8. The apparatus according to claim 6, wherein the processor is further configured to perform heterogeneous data transfer learning on the training data by using covariance shift, multi-task learning, a sample TrAdaboost transfer learning method, a probabilistic latent semantic analysis (PLSA) algorithm, a principal component analysis (PCA) algorithm, a linear discriminant analysis (LDA) algorithm, a Bayesian model, a support vector machine, or a theme model to learn the semanteme of the training data.

9. An apparatus for recommending a user in a social network, comprising:
a processor configured to:
obtain related data of a target user, wherein the related data of the target user comprises at least image data;
search, by using a user recommendation model, for a user having a semantic association relationship with the image data of the target user, wherein the user recommendation model is established by performing heterogeneous data transfer learning on training data; and
recommend a user corresponding to the semantic association relationship satisfying a preset condition to the target user when the semantic association relationship satisfies the preset condition.

10. The apparatus according to claim 9, wherein the recommendation module is configured to push identifier data of the user to the target user.

11. A computer device, comprising:
a processor;
a memory configured to store a computer execution instruction;
a bus coupling the memory to the processor; and
a communications interface,
wherein the processor executes the computer execution instruction stored in the memory to cause the processor to:
obtain training data from the social network, wherein the training data comprises text data, image data, and user-related data;
perform heterogeneous data transfer learning on the training data to learn a semanteme of the training data;
establish a first association between a user and the image data by using the text data as a medium;
establish a semantic association relationship between the image data and the user according to the semanteme of the training data and the first association between the user and the image data; and
establish a user recommendation model according to the semantic association relationship, wherein the user recommendation model comprises the semantic association relationship between the image data and the user.

12. A computer device, comprising:
a processor;
a memory configured to store a computer execution instruction;
a bus coupling the memory to the processor; and
a communications interface,
wherein the processor executes the computer execution instruction stored in the memory to cause the processor to:
obtain related data of a target user, wherein the related data of the target user comprises at least image data;
search, by using a user recommendation model, for a user having a semantic association relationship with the image data of the target user, wherein the user recommendation model is established by performing heterogeneous data transfer learning on training data; and
recommend a user corresponding to the semantic association relationship satisfying a preset condition to the target user when the semantic association relationship satisfies the preset condition.

13. A computer readable medium comprising a computer execution instruction that when a processor of a computer executes the computer execution instruction, causes the processor to:
obtain training data from the social network, wherein the training data comprises text data, image data, and user-related data;
perform heterogeneous data transfer learning on the training data to learn a semanteme of the training data;
establish a first association between a user and the image data by using the text data as a medium;
establish a semantic association relationship between the image data and the user according to the semanteme of the training data and the first association between the user and the image data; and
establish a user recommendation model according to the semantic association relationship, wherein the user recommendation model comprises the semantic association relationship between the image data and the user.

14. A computer readable medium comprising a computer execution instruction that when a processor of a computer executes the computer execution instruction, causes the processor to:
obtain related data of a target user, wherein the related data of the target user comprises at least image data;
search, by using a user recommendation model, for a user having a semantic association relationship with the image data of the target user, wherein the user recommendation model is established by performing heterogeneous data transfer learning on training data; and
recommend a user corresponding to the semantic association relationship satisfying a preset condition to the target user when the semantic association relationship satisfies the preset condition.
